(19) United States
(12) Patent Application Publication
(10) Pub. No.: US 2025/0135966 A1
(43) Pub. Date: May 1, 2025

(54) CHILD RESTRAINT

(71) Applicant: Dorel Juvenile Group, Inc., Foxboro, MA (US)

(72) Inventors: William P. MCHUGH, Norfolk, MA (US); Jason H. JOHNSON, Brownstown, IN (US); Grant M. MASON, Wrentham, MA (US)

(21) Appl. No.: 18/925,774

(22) Filed: Oct. 24, 2024

Related U.S. Application Data
(60) Provisional application No. 63/545,648, filed on Oct. 25, 2023.

(51) Int. Cl. B60N 2/28

(52) U.S. Cl. CPC B60N 2/2821; B60N 2/2869

(57) ABSTRACT

A child restraint includes a seat base, and a juvenile seat coupled to the seat base. The seat base may include a seat-base foundation adapted to rest on a vehicle seat and a seat-orientation controller coupled to the seat-base foundation for rotation about a vertical rotation axis. The juvenile seat is configured to couple to the seat-orientation controller to be secured to the vehicle seat. The juvenile seat is rotatable relative to the seat-base foundation about the vertical rotation axis with the seat-orientation controller between a travel orientation, including a forward-facing orientation and a rearward-facing orientation relative to the seat-base foundation, and a sideways orientation relative to the seat-base foundation.

### PRIORITY CLAIM

This application claims priority under 35 U.S.C. § 119 (e) to U.S. Provisional Patent Application No. 63/545,648, filed Oct. 25, 2023, which is expressly incorporated by reference herein in its entirety.

### BACKGROUND

The present disclosure relates to a child safety device, and particularly to a child car seat. More particularly, the present disclosure relates to a child car seat with multiple modes of use.

### SUMMARY

According to the present disclosure, a child restraint includes a seat base and a juvenile seat coupled to the seat base. The seat base may include a seat-base foundation adapted to rest on a vehicle seat and a seat-orientation controller coupled to the seat-base foundation for rotation about a vertical rotation axis. The juvenile seat is configured to couple to the seat-orientation controller to be secured to the vehicle seat. The juvenile seat is rotatable relative to the seat-base foundation about the vertical rotation axis with the seat-orientation controller between: (i) a travel orientation, including a forward-facing orientation and a rearward-facing orientation relative to the seat-base foundation, and (ii) a sideways orientation relative to the seat-base foundation.

In illustrative embodiments, the child restraint further includes a rotation-blocking system including a travel-orientation rotation blocker and a sideways-orientation rotation blocker. The travel orientation rotation blocker is mounted to a front end of the seat-base foundation and is configured to engage the seat-orientation controller in the forward-facing orientation and the rearward facing orientation to block rotation of the seat-orientation controller and the juvenile seat about the vertical rotation axis. The sideways-orientation rotation blocker is fixed to the seat-base foundation and spaced circumferentially from the travel-orientation rotation blocker. The sideways-orientation rotation blocker is configured to engage the seat-orientation controller when the juvenile seat is in the sideways orientation to restrict movement of the seat-orientation controller and the juvenile seat about the vertical rotation axis.

In illustrative embodiments, the sideways-orientation rotation blocker includes a first rotation blocker coupled to a first lateral side of the seat-base foundation and a second rotation blocker coupled to a second lateral side of the seat-base foundation. In illustrative embodiments, the sideways-orientation rotation blocker includes a pivot axle, an arm, and a projection. The pivot axle is mounted in a fixed position relative to the seat-base foundation. The arm extends away from the pivot axle and interconnects the pivot axle and the projection. The projection is coupled to a distal end of the arm spaced apart from the pivot axle and is configured to engage the seat-orientation controller to restrict rotation of the seat-orientation controller and the juvenile seat about the vertical rotation axis.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective and diagrammatic view of a child restraint, in accordance with the present disclosure, including a seat base adapted to be secured to a vehicle seat for movement therewith in a vehicle and a juvenile seat configured to be coupled to the seat base for pivotal movement relative to at least a portion of the seat base about a vertical pivot axis between a travel orientation, including a forward-facing orientation and/or a rearward-facing orientation, and a sideways, installation orientation, as shown in FIGS. 3 and 16, where a child-receiving space defined by the juvenile seat faces toward a doorway of the vehicle to place a child into the child-receiving space or remove a child from the child-receiving space;

FIG. 2 is an enlarged view of a portion of the seat base of FIG. 1 showing the seat base including a juvenile-seat rotation blocking system including a sideways-orientation rotation blocker configured to restrict movement of the juvenile seat about the vertical pivot axis when the juvenile seat is in the sideways, installation orientation;

FIG. 3 is a perspective and diagrammatic view of the child restraint showing the juvenile seat and a seat-orientation controller included in the seat base in the sideways, installation orientation;

FIG. 4 is an enlarged view of a portion of FIG. 3 with the seat-orientation controller removed and outlined in dashed lines in the sideways, installation orientation to show portions of the sideways-orientation rotation blocker engaging with the seat-orientation controller to restrict movement of the juvenile seat about the vertical pivot axis;

FIG. 5 is an exploded assembly view of the seat base including the seat-orientation controller and a seat-base foundation and configured to mount the juvenile seat to the seat base for rotation about the vertical pivot axis relative to the seat-base foundation;

FIG. 6 is a top view of the seat base with portions of the seat-orientation controller removed and showing the seat-orientation controller at an orientation between the travel orientation and the sideways, installation orientation before the seat-orientation engages with the sideways-orientation rotation blocker;

FIG. 7 is an enlarged view of a portion of the seat base from FIG. 7 showing a seat motion blocker included in the seat-orientation controller positioned adjacent to a first motion restrictor included in the sideways-orientation rotation blocker at the orientation between the travel orientation and the sideways, installation orientation;

FIG. 8 is a top view of the seat base with portions of the seat-orientation controller removed showing the seat orientation controller in the sideways, installation orientation and showing first and second seat motion blockers included in the seat orientation controller engaged with first and second motion restrictors included in the sideways-orientation rotation blocker to restrict movement of the seat-orientation controller and the juvenile seat about the vertical pivot axis;

FIG. 9 is an enlarged view of a portion of the seat base showing one of the motion restrictors included in the sideways-orientation rotation blocker in a raised position protruding into a travel path of the first and second seat motion blockers included in the seat-orientation controller;

FIG. 10 is an enlarged view of a portion of the seat base showing one of the motion restrictors in a lowered position withdrawn from the travel path of the first and second seat motion blockers in response to one of the seat motion blockers traveling over the motion restrictors as the juvenile seat rotates about the vertical pivot axis;

FIG. 11 is a cross section of a portion of the seat base taken along line 11-11 in FIG. 9 showing the motion restrictor in the raised position;

FIG. 12 is a cross section of a portion of the seat base taken along line 12-12 in FIG. 10 showing the motion restrictor in the lowered position;

FIG. 13 is a perspective view of one of the motion restrictors and a housing also included in the sideways-orientation rotation blocker and showing an orientation indicator coupled to the housing to provide an assembled unit;

FIG. 14 is an exploded assembly view of the assembled unit of FIG. 13;

FIG. 15 is a perspective view of the child restraint in the travel orientation; and

FIG. 16 is a perspective view of the child restraint in the sideways, installation orientation.

### DETAILED DESCRIPTION

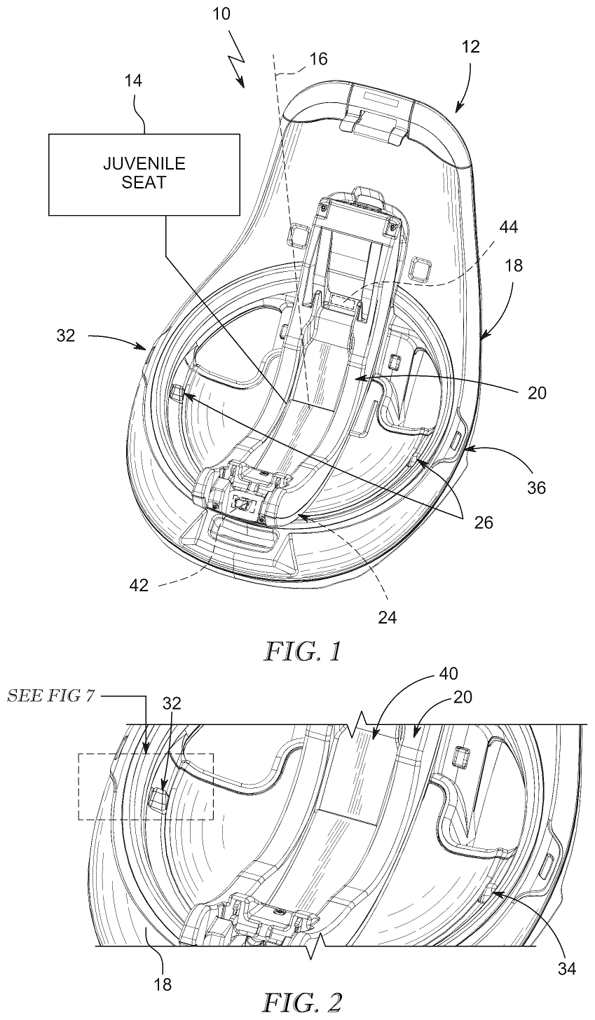

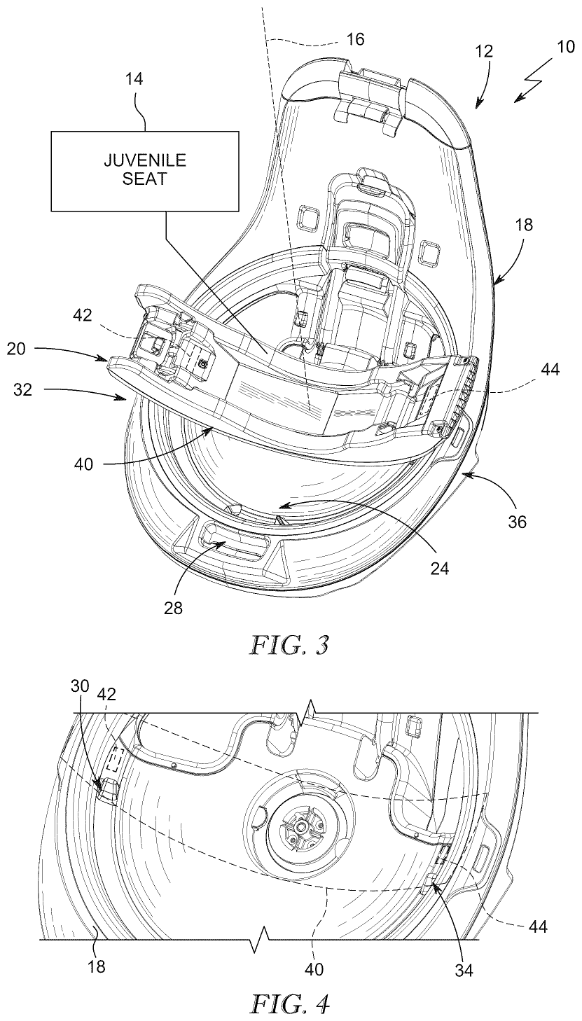

A child restraint 10 includes a seat base 12 and a juvenile seat 14 mounted to the seat base 12 for rotation relative to the seat base 12 about a vertical rotation axis 16 as suggested in FIGS. 1 and 3. The juvenile seat 14 is configured to rotate about the vertical rotation axis 16 from a travel orientation, in which the juvenile seat 14 is arranged in either a forward-facing orientation or a rearward-facing orientation relative to the seat base 12 as suggested in FIG. 1, and a sideways orientation relative to the seat base 12 for facilitated loading and unloading of a child to and from the juvenile seat 14 as suggested in FIG. 3. In illustrative embodiments, the child restraint further includes a sideways-orientation rotation blocker 26 configured to block rotation of the juvenile seat 14 relative to the seat base 12 so that the juvenile seat 14 does not unintentionally rotate about the vertical rotation axis 16 during loading and unloading of the child from the juvenile seat 14.

The seat base 12 includes a seat-base foundation 18 adapted to rest on a vehicle seat 11 and a seat-orientation controller 20 coupled to the seat-base foundation 18 for rotation about the vertical rotation axis 16 with the juvenile seat 14 and relative to the seat-base foundation 18 as shown in FIGS. 1-4. The seat-base foundation 18 is configured to support the seat-orientation controller 20 and the juvenile seat 14 relative to the vehicle seat 11. The seat-orientation controller 20 is configured to mount the juvenile seat 14 to the seat-base foundation 18 to permit the juvenile seat 14 to rotate between the travel orientation and the sideways orientation. In some embodiments, the seat-orientation controller 20 may be omitted and the juvenile seat 20 can be mounted directly to the seat-base foundation 18. Reference is hereby made to U.S. Provisional Application No. 63/419,505 filed Oct. 26, 2022 and entitled CHILD RESTRAINT for disclosure relating to use of a seat base, which application is hereby incorporated in its entirety herein.

The juvenile seat 14 is configured to couple to the seat-orientation controller to be secured to the vehicle seat 11. The juvenile seat 14 is rotatable relative to the seat-base foundation 18 about the vertical rotation axis 16 with the seat-orientation controller 20 between: (i) the travel orientation, including the forward-facing orientation and the rearward-facing orientation relative to the seat-base foundation 18, and (ii) the sideways orientation relative to the seat-base foundation 18.

In illustrative embodiments, the child restraint 10 further includes a rotation-blocking system 22 configured to control rotation of the juvenile seat 14 and the seat-orientation controller 20 relative to the seat-base foundation 18. The rotation-blocking system 22 includes a travel-orientation rotation blocker 24 and the sideways-orientation rotation blocker 26. The travel-orientation rotation blocker 24 is mounted to a front end of the seat-base foundation 18 and is configured to engage the seat-orientation controller 20 in the forward-facing orientation and the rearward facing orientation to block rotation of the seat-orientation controller 20 and the juvenile seat 16 about the vertical rotation axis selectively. The seat-base foundation 18 includes a release handle 28 which can be actuated by a user to disengage the travel-orientation rotation blocker 24 from the seat-orientation controller 20 to free the juvenile seat 14 to rotate about the vertical rotation axis 16. The sideways-orientation rotation blocker 26 is fixed to the seat-base foundation 18 and is spaced circumferentially from the travel-orientation rotation blocker 24. The sideways-orientation rotation blocker 26 is configured to engage the seat-orientation controller 20 when the juvenile seat 14 is in the sideways orientation to block movement of the seat-orientation controller 20 and the juvenile seat 14 about the vertical rotation axis 16.

The sideways-orientation rotation blocker 26 is illustratively embodied as a temporary detent or soft lock to hold the juvenile seat 14 in the sideways orientation for loading and unloading of a child. Once loading or unloading of the child is complete, the user can overcome the sideways-orientation rotation blocker 26 by applying a rotational force on the juvenile seat 14 above a predetermined amount to return the juvenile seat to the travel orientation without having to actuate any handles, buttons, grips, etc. The sideways-orientation rotation blocker 26 includes a first rotation blocker 30 coupled to a first lateral side 32 of the seat-base foundation 18 and a second rotation blocker 34 coupled to an opposite, second lateral side 36 of the seat-base foundation 18. The first and second rotation blockers 30, 34 may cooperate with one another to retain the juvenile seat 14 in the sideways orientation. In some embodiments, the rotation blockers 30, 34 may operate independently of one another, or the child restraint 10 may include only one rotation blocker configured to hold the juvenile seat 14 in the sideways orientation.

The first rotation blocker 30 is spaced apart circumferentially from the travel-orientation rotation blocker 24 less than or equal to 90 degrees in a first direction from the travel-orientation rotation blocker 24 about the vertical rotation axis 16. The second rotation blocker 34 is spaced apart circumferentially from the travel-orientation rotation blocker 24 less than or equal to 90 degrees in a second direction, opposite the first direction, from the travel-orientation rotation blocker 24 about the vertical rotation axis 16. The first and second rotation blockers 30, 34 may be spaced circumferentially from the travel-orientation rotation blocker 24 by more or less than 90 degrees, such as about 90 degrees or within a range of about 85 degrees to about 95 degrees. In other words, the first and second rotation blockers 30, 34 are spaced circumferentially from one another less than 180 degrees in a first direction and more than 180 degrees in a second, opposite direction.

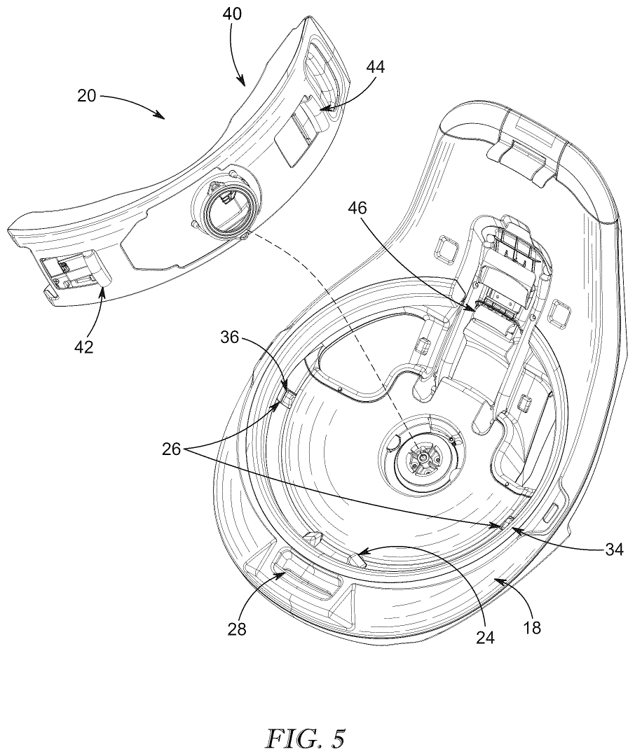

The seat-orientation controller 20 includes an attachment body 40, a first seat-motion blocker 42 coupled to a lower end of the attachment body 40, and a second seat-motion blocker 44 coupled to the lower end of the attachment body 40 as shown in FIGS. 2, 4, and 5. The first seat-motion blocker 42 is located at a forward end of the attachment body 40. The second seat-motion blocker 44 is located at a rear end of the attachment body 40. In the travel orientation, one of the seat-motion blockers 42, 44 is configured to engage the travel-orientation rotation blocker 24 to lock the juvenile seat 14 in the travel orientation. The other of the seat-motion blockers 42, 44 is configured to interlock with a corresponding seat retainer 46 fixed to the seat-base foundation 18 at a location rearward from the vertical rotation axis 16. In the sideways orientation, the first seat-motion blocker 42 is configured to engage the first rotation blocker 30 and the second seat-motion blocker 44 is configured to engage the second rotation blocker 34. Illustratively, each of the seat-motion blockers 42, 44, 46 is embodied as a flange, such as a J-shaped flange, an L-shaped flange, or any other suitable structure or shape.

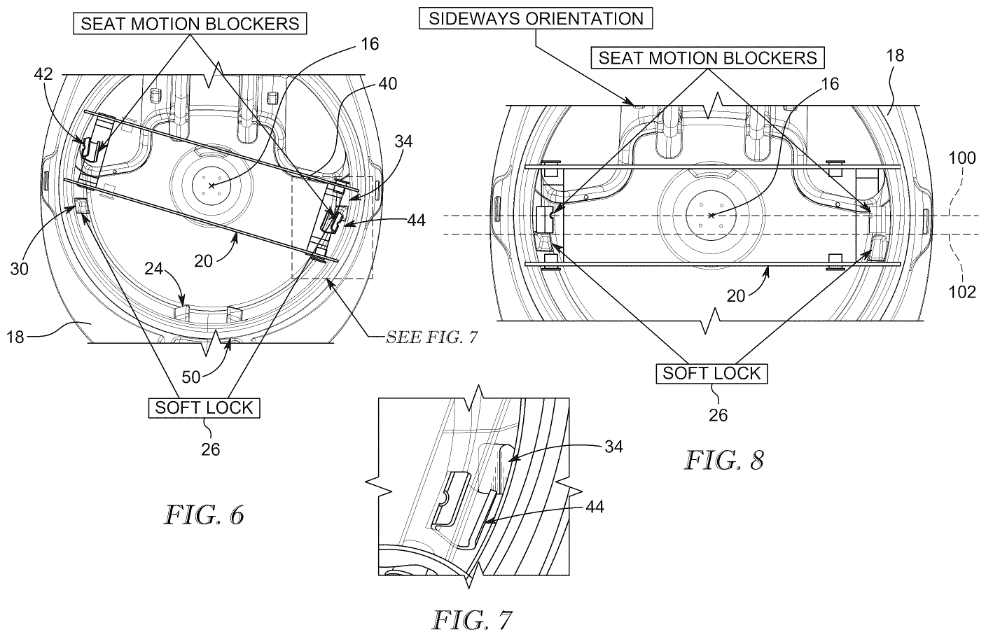

The first and second seat-motion blockers 42, 44 are arranged to lie along a first line 100 passing through the vertical rotation axis 16 and the first and second rotation blockers 30, 34 are arranged to lie along a second line 102 offset from the vertical rotation axis 16 as shown in FIG. 6. The second line 102 is offset forward from the vertical rotation axis 16 to locate the second line 102 between a front end 50 of the seat-base foundation 18 and the first line 100 when the seat-orientation controller 20 and the juvenile seat 14 are in the sideways orientation. The first and second seat-motion blockers 42, 44 are positioned on a rear-facing side of each respective rotation blocker 30, 34 when the seat-orientation controller 20 and the juvenile seat 14 are in the sideways orientation. Thus, the first rotation blockers 30 engages one of the seat-motion blockers 42, 44 to restrict rotation of the juvenile seat 14 in a first direction and the second rotation blocker engages the other of the seat-motion blockers 42, 44 to restrict rotation of the juvenile seat 14 in a second opposite direction. In some embodiments, first and second rotation blockers 30, 34 can straddle one of the seat-motion blockers 42, 44 to restrict rotation of the juvenile seat 14 in both directions.

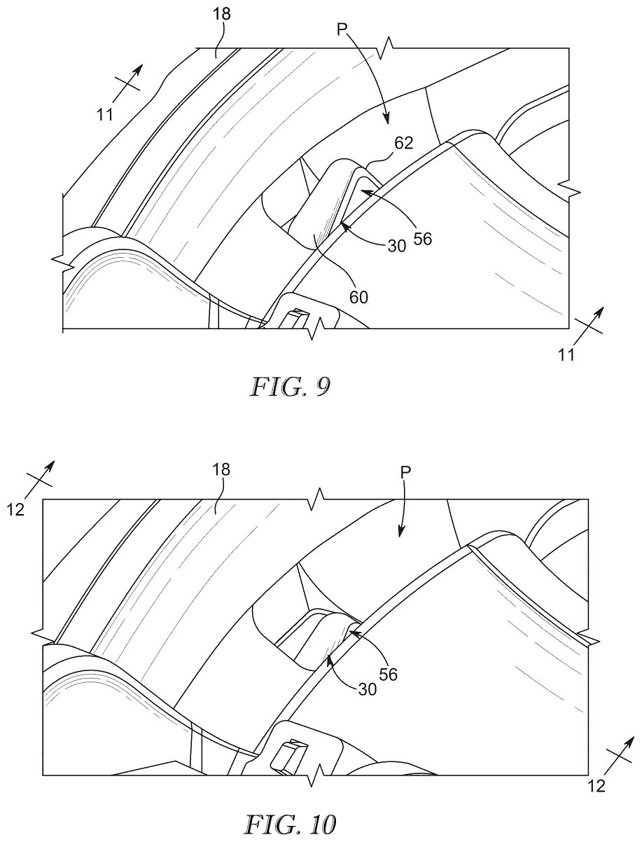

Each rotation blocker 30, 34 of the sideways-orientation rotation blocker 24 includes a pivot axle 52 mounted in a fixed position relative to the seat-base foundation 18, an arm 54 extending away from the pivot axle 52, and a projection 56 coupled to a distal end of the arm 54 spaced apart from the pivot axle 52 as shown in FIGS. 7-12. The projection 56 and the arm 54 are pivotable about a blocker axis 58 provided by the pivot axle 52 between an extended position and a retracted position as shown in FIGS. 7-10. In the extended position, the projections 56 extend into a travel path P of the seat-motion blockers 42, 44 to block rotation of the seat-orientation controller 20 and the juvenile seat 14 about the vertical rotation axis 16 when the seat-motion blockers 42, 44 are positioned on the rearward side of the rotation blockers 30, 34. In the retracted position, the projections 56 pivot about blocker axis 58 out of the travel path P.

The projection 56 and the arm 54 are normally biased toward the extended position (i.e. by a spring) to temporarily hold the seat-orientation controller 20 and the juvenile seat 14 in the sideways orientation. The projection 56 and the arm 54 are configured to pivot to the retracted position in response to application of a rotation force on the seat-orientation controller 20 or the juvenile seat 14 above a predetermined amount during movement of the seat-orientation controller 20 and the juvenile seat 14 about the vertical rotation axis 16 past the sideways-orientation rotation blocker 24. Illustratively, the predetermined force is defined partially in relation to the spring constant of the spring such that the projection 56 can only retract by overcoming the spring constant and compressing the spring.

The projection 56 includes a first angled wall 60 facing in a first circumferential direction about the vertical rotation axis 16 and a second angled wall 62 facing in a second circumferential direction about the vertical rotation axis 16 opposite the first circumferential direction. The first angled wall 60 has a first slope and the second angled wall 62 has a second slope greater than the first slope. The slopes of the walls 60, 62 control the amount of force required to change the projection 56 from the extended position to the retracted position. For example, movement of the juvenile seat 14 in first circumferential direction about the vertical rotation axis 16 with a first force causes the one of the seat-motion blockers 42, 44 to engage wall 60 and change the projection 56 from the extended position to a retracted position. Movement of the juvenile seat 14 in a second, opposite circumferential direction with a second force, greater than the first force, causes one of the seat-motion blockers 42, 44 to engage wall 62 to change the projection 56 from the extended position to the retracted position. The second force is greater because the slope of wall 62 is greater than the slope of wall 60. Rotation of the juvenile seat 14 about the vertical rotation axis 16 in the second circumferential direction is blocked by the wall 62 with application of only the first force.

The projection 56 further includes a radial wall 64 facing away from the pivot axle 52. The radial wall 64 may be angled to incline inwardly toward the vertical rotation axis 16 to provide clearance for the projection 56 to move from the extended position to the retracted position though an opening 66 formed in the seat-base foundation 18.

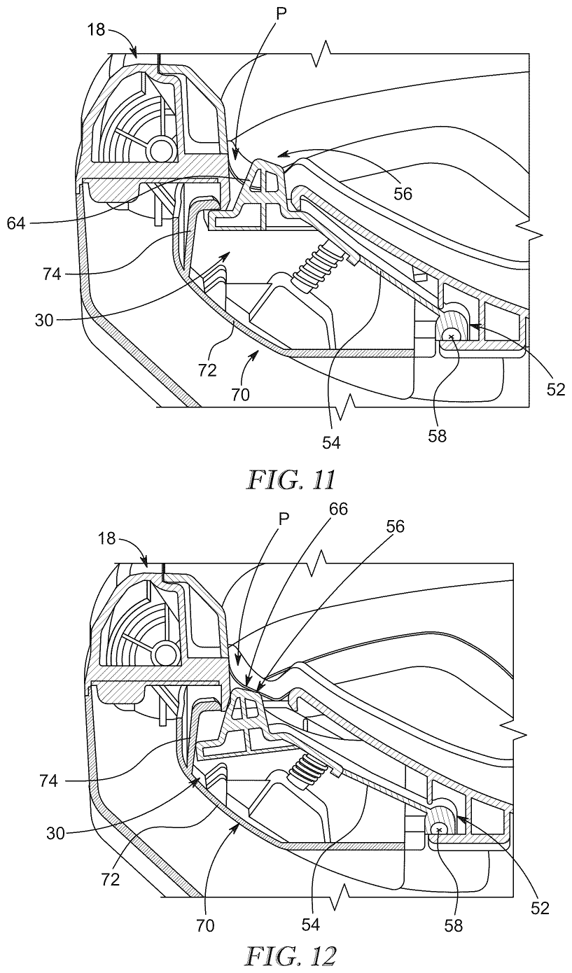

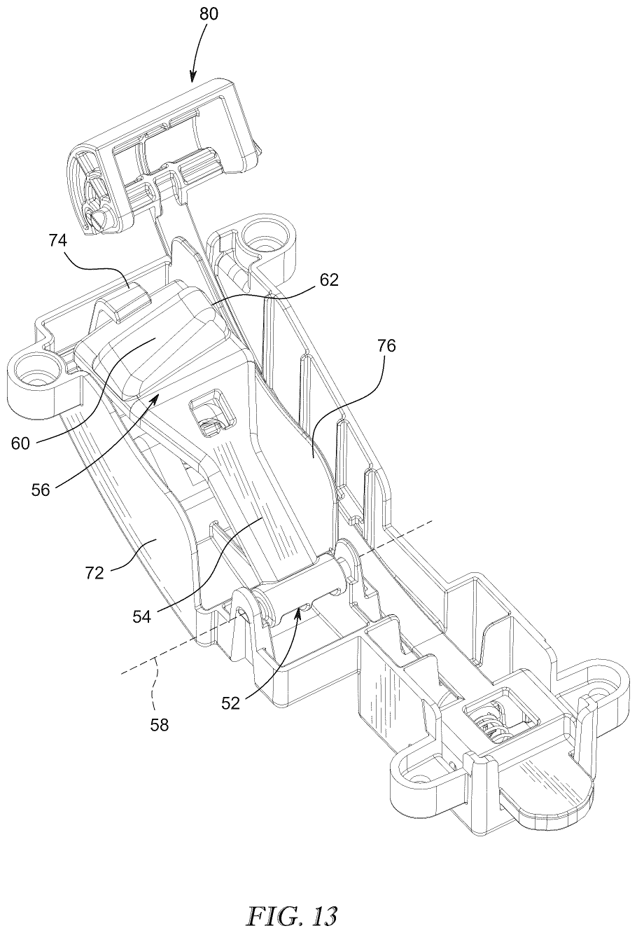

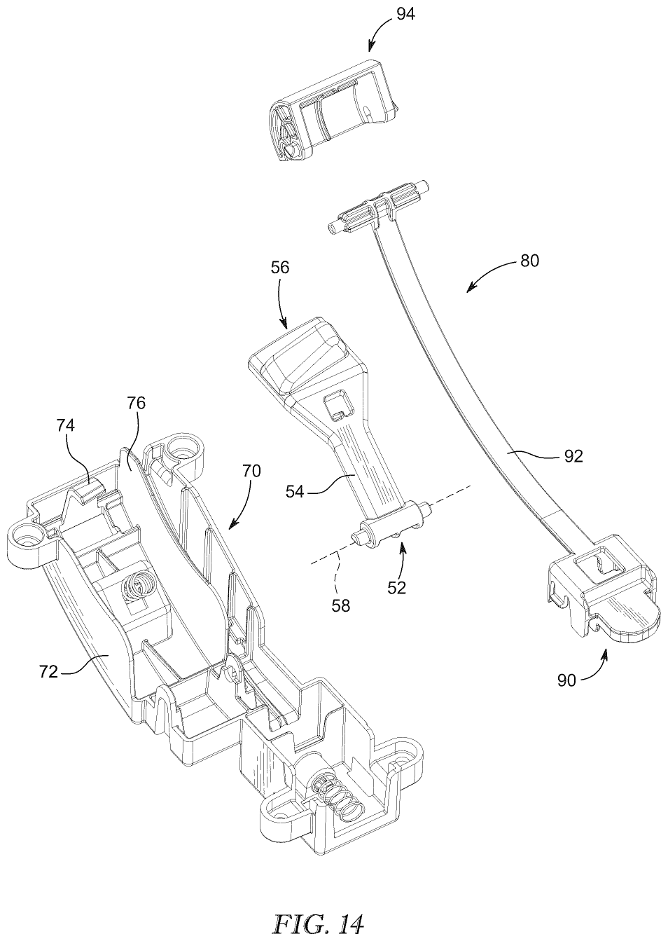

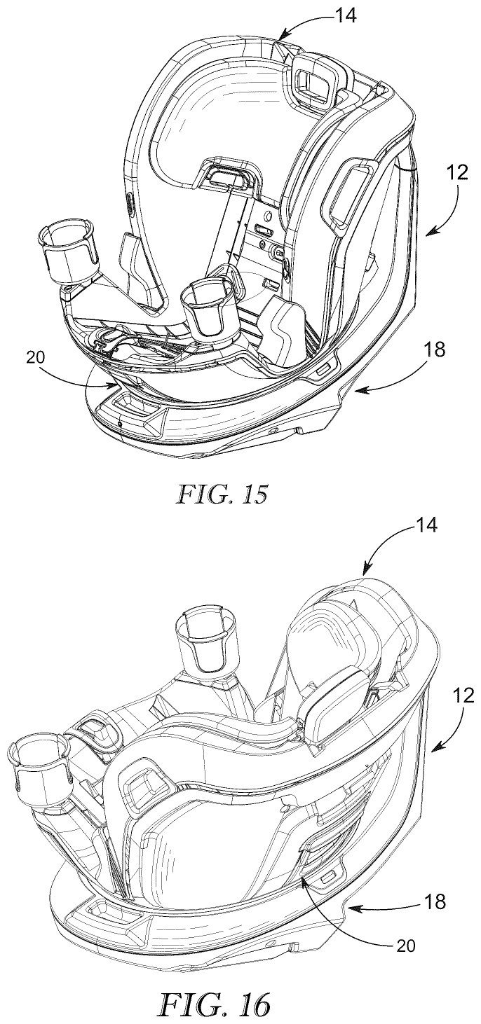

The sideways-orientation rotation blocker 24 may further include an axle mount 70 fixed to the seat-base foundation 18 to support the pivot axle 52 relative to the seat-base foundation 18 as shown in FIGS. 11-13. The axle mount 70 includes a mount body 72 fixed to the seat-base foundation 18 and a projection stop 74 fixed to the mount body 72 and configured to engage a portion of the arm 54 or the projection 56 when the projection is in the extended position. The axle mount 70 is detachable from the seat-base foundation 18 so that the sideways-orientation rotation blocker 24 can be manufactured separately from the seat-base foundation 18 and later assembled with the seat-base foundation 18. The projection 56 and arm 54 remain fixed in place relative to the axle mount 70 to provide an assembled unit, as shown in FIG. 13, when the axle mount 70 is detached from the seat-base foundation 18.

The axle mount 70 may further include a divider wall 76 establishing multiple sub-spaces to house various components of the child restraint 10. For example, the child restraint 10 may further include a rotation indicator 80 configured to indicate when the juvenile seat 14 is in the travel orientation and/or the sideways orientation. The rotation indicator 80 is located in a separate sub-space from portions of the axle 52, arm 54 and projection 56. Illustratively, the rotation indicator 80 includes a movable projection 90 that is configured to engage a portion of the seat-orientation controller 20 or the juvenile seat 14 as the juvenile seat 14 rotates, a flexible, actuator arm 92 movable with the projection 90, and an indicator plate 94 moved by the actuator arm 92 to display different appearances and indicate the orientation of the juvenile seat to users. The rotation indicator 80 is configured to couple with the axle mount 70 to provide a portion of the assembled unit.

1. A child restraint comprising
a seat base including a seat-base foundation adapted to rest on a vehicle seat and a seat-orientation controller coupled to the seat-base foundation for rotation about a vertical rotation axis,
a juvenile seat configured to couple to the seat-orientation controller to be secured to the vehicle seat, the juvenile seat being rotatable relative to the seat-base foundation about the vertical rotation axis with the seat-orientation controller between: (i) a travel orientation, including a forward-facing orientation and a rearward-facing orientation relative to the seat-base foundation, and (ii) a sideways orientation relative to the seat-base foundation, and
a rotation-blocking system including a travel-orientation rotation blocker mounted to a front end of the seat-base foundation and configured to engage the seat-orientation controller in the forward-facing orientation and the rearward facing orientation to block rotation of the seat-orientation controller and the juvenile seat about the vertical rotation axis, and a sideways-orientation rotation blocker fixed to the seat-base foundation and spaced circumferentially from the travel-orientation rotation blocker and configured to engage the seat-orientation controller when the juvenile seat is in the sideways orientation to restrict movement of the seat-orientation controller and the juvenile seat about the vertical rotation axis.

2. The child restraint of claim 1, wherein the sideways-orientation rotation blocker includes a first rotation blocker coupled to a first lateral side of the seat-base foundation and a second rotation blocker coupled to a second lateral side of the seat-base foundation.

3. The child restraint of claim 2, wherein the first rotation blocker is spaced apart circumferentially from the travel-orientation rotation blocker less than 90 degrees in a first direction from the travel-orientation rotation blocker about the vertical rotation axis and the second rotation blocker is spaced apart circumferentially from the travel-orientation rotation blocker less than 90 degrees in a second direction, opposite the first direction, from the travel-orientation rotation blocker about the vertical rotation axis.

4. The child restraint of claim 2, wherein the seat-orientation controller includes an attachment body, a first seat-motion blocker coupled to a lower end of the attachment body at a forward end of the attachment body, and a second seat-motion blocker coupled to the lower end of the attachment body at a rear end of the attachment body, and wherein the first seat-motion blocker is configured to engage the first rotation blocker and the second seat-motion blocker is configured to engage the second rotation blocker when the juvenile seat and the seat-orientation controller are in the sideways orientation.

5. The child restraint of claim 4, wherein, when the juvenile seat is in the sideways orientation, the first and second seat-motion blockers are arranged to lie along a first line passing through the vertical rotation axis and the first and second rotation blockers are arranged to lie along a second line offset from the vertical rotation axis.

6. The child restraint of claim 5, wherein the second line is offset forward from the vertical rotation axis to locate the second line between a front end of the seat-base foundation and the first line when the seat-orientation controller and the juvenile seat are in the sideways orientation.

7. The child restraint of claim 5, wherein the first and second seat-motion blockers are positioned on a rear-facing side of each respective rotation blocker when the seat-orientation controller and the juvenile seat are in the sideways orientation.

8. The child restraint of claim 1, wherein the sideways-orientation rotation blocker includes a pivot axle mounted in a fixed position relative to the seat-base foundation, an arm extending away from the pivot axle, and a projection coupled to a distal end of the arm spaced apart from the pivot axle and configured to engage the seat-orientation controller to block rotation of the seat-orientation controller and the juvenile seat about the vertical rotation axis.

9. The child restraint of claim 8, wherein the projection and the arm are pivotable about a blocker axis provided by the pivot axle between an extended position extending into a travel path of a portion of the seat-orientation controller blocking rotation of the seat-orientation controller and the juvenile seat about the vertical rotation axis and a retracted position out of the travel path.

10. The child restraint of claim 9, wherein the projection and the arm are biased toward the extended position to temporarily hold the seat-orientation controller and the juvenile seat in the sideways orientation, and the projection and the arm are configured to pivot to the retracted position in response to application of a rotation force on the seat-orientation controller above a predetermined amount during movement of the seat-orientation controller and the juvenile seat about the vertical rotation axis past the sideways-orientation rotation blocker.

11. The child restraint of claim 10, wherein the projection includes a first angled wall facing in a first circumferential direction about the vertical rotation axis and a second angled wall facing in a second circumferential direction about the vertical rotation axis opposite the first circumferential direction.

12. The child restraint of claim 11, wherein the first angled wall has a first slope and the second angled wall has a second slope greater than the first slope.

13. The child restraint of claim 10, wherein the projection further includes a radial wall facing away from the pivot axle, and the radial wall is angled to incline inwardly toward the vertical rotation axis to provide clearance for the projection to move from the extended position to the retracted position.

14. The child restraint of claim 9, wherein the sideways-orientation rotation blocker further includes an axle mount fixed to the seat-base foundation to support the pivot axle relative to the seat-base foundation.

15. The child restraint of claim 14, wherein the axle mount includes a mount body fixed to the seat-base foundation and a projection stop fixed to the mount body and configured to engage a portion of the arm or the projection when the projection is in the extended position.

16. The child restraint of claim 15, wherein the axle mount is detachable from the seat-base foundation and the projection and arm remain fixed in place relative to the axle mount when the axle mount is detached from the seat-base foundation.

17. The child restraint of claim 9, wherein the seat-orientation controller includes an attachment body, a seat-retainer unit coupled to an upper end of the attachment body and configured to retain the juvenile seat to the attachment body, and a motion-blocking unit, including a first motion-blocking flange and a second motion-blocking flange, coupled to a lower end of the attachment body and configured to block movement of the juvenile seat and the seat-orientation controller relative to the seat-base foundation when the juvenile seat is in the forward-facing orientation and the rearward-facing orientation, and wherein the first and second motion-blocking flanges are configured to engage the projection in response to rotation of the juvenile seat about the vertical rotation axis past the projection with a predetermined rotation force to move the projection from the extended position to the retracted position.

18. The child restraint of claim 17, wherein one of the first and second motion blocking flanges is configured to engage the projection in the extended position to block rotation of the juvenile seat about the vertical rotation axis in response to application of a second rotation force less than the predetermined rotation force.

19. A child restraint comprising
a seat base adapted to rest on a vehicle seat,
a juvenile seat configured to couple to the seat base to be secured to the vehicle seat, the juvenile seat being rotatable relative to the seat base about a vertical rotation axis: (i) a travel orientation, including a forward-facing orientation and a rearward-facing orientation, and (ii) a sideways orientation, and
a sideways-orientation rotation blocker fixed to the seat base and configured to engage the seat-orientation controller when the juvenile seat is in the sideways orientation to restrict movement of the juvenile seat about the vertical rotation axis,
wherein movement of the juvenile seat in first circumferential direction about the vertical rotation axis with a first force causes the sideways-orientation rotation blocker to change from an extended position to a retracted position and movement of the juvenile seat in a second, opposite circumferential direction with a second force, greater than the first force, causes the sideways-orientation rotation blocker to change from the extended position to the retracted position, and
wherein rotation of the juvenile seat about the vertical rotation axis in the second, opposite circumferential direction is blocked with application of the first force.

20. The child restraint of claim 19, wherein the sideways-orientation rotation blocker includes a projection moveable between the extended position and the retracted position, and wherein the projection includes a first angled wall facing in a first circumferential direction about the vertical rotation axis and having a first slope to provide the first force and a second angled wall facing in a second circumferential direction about the vertical rotation axis opposite the first circumferential direction and having a second slope greater than the first slope to provide the second force.
